(19) United States
(12) Patent Application Publication
(10) Pub. No.: US 2026/0163818 A1
(43) Pub. Date: Jun. 11, 2026

(54) APPARATUS AND METHOD OF NETWORK CONTROL USING LANGUAGE MODEL

(71) Applicant: ELECTRONICS AND TELECOMMUNICATIONS RESEARCH INSTITUTE, Daejeon (KR)

(72) Inventors: YongWook RA, Daejeon (KR); Chansung PARK, Daejeon (KR); Hwan Seok CHUNG, Daejeon (KR)

(73) Assignee: ELECTRONICS AND TELECOMMUNICATIONS RESEARCH INSTITUTE, Daejeon (KR)

(21) Appl. No.: 19/409,479

(22) Filed: Dec. 4, 2025

(30) Foreign Application Priority Data
Dec. 11, 2024 (KR) 10-2024-0183295

(51) Int. Cl. H04L 41/16; G06F 16/3329

(52) U.S. Cl. CPC H04L 41/16; G06F 16/33295

(57) ABSTRACT

The present invention relates to an apparatus and method for network control using a language model. The method of network control according to the present invention includes receiving a network control request message from an operator, obtaining an entity search result related to the network control request message from a database storing network information, generating a prompt based on the entity search result, inputting the prompt to the language model to obtain a language model response text, and generating a network control command based on the language model response text.

### CROSS-REFERENCE TO RELATED APPLICATION

This application claims priority under 35 U.S.C. § 119 to Korean Patent Application No. 10-2024-0183295, filed on Dec. 11, 2024, in the Korean Intellectual Property Office, the disclosure of which is incorporated herein by reference in its entirety.

### BACKGROUND

### 1. Field of the Invention

The present invention relates to an intelligence function based on an artificial intelligence language model for control and management of network elements separated into a data plane and a control plane. In other words, the present invention relates to an apparatus and method for controlling and managing a complex physical network using an artificial intelligence language model.

### 2. Discussion of Related Art

The explosive growth of data, along with advancements in machine learning algorithms and model architectures such as transformers, has provided a major breakthrough in the development of large language models. Artificial intelligence language models, previously limited to translation or simple text processing in the past, may now perform complex tasks across various applications, including those related to customer service, healthcare, law, finance, and network development, and enhance operational efficiency. The language models are being utilized as a general approach for operators or developers to introduce intelligence functions into services/applications/systems and the like due to their accessibility and ease of use.

In this way, the language models enable operators to utilize advanced artificial intelligence technology in services/applications/systems and the like applicable in various fields while saving cost and time. However, when constructing a physical network (e.g., optical access network, transport network, etc.), different control methods (e.g., network equipment specifications, complex control instructions, etc. according to domain information and domain characteristics) should be applied depending on hardware (e.g., network elements), so it is not easy to utilize a language model for network control.

Two methods have been proposed to increase the capacity of the physical network and easily add or delete software functions without relying on vendor-specific equipment and technology. The first method is a method of disaggregating a network into a data plane (hardware) and a control plane (software) and subsequently applying software defined networking (SDN) and network function virtualization (NFV) technologies to the control plane. The second method is a method of adding hardware abstraction technology between a data plane and a control plane so that different interfaces may be accommodated for various access technologies (a gigabit passive optical network (GPON), 10 gigabit symmetrical passive optical network (XGS-PON), next-generation passive optical network 2 (NGPON2), 25 gigabit symmetrical passive optical network (25GS-PON), 50 gigabit passive optical network (50G-PON), etc.). However, despite the introduction of these methods, operators still face the challenge of training complex workflows to construct, control, and manage networks or to rapidly adapt network architectures to the specific attributes of different services.

In particular, when trying to control or manage networks through a service-type language model, operators do not need to understand complex workflows, but they face the challenge of frequently intervening to generate command prompts and individually applying responses from the language model to the network control plane.

Therefore, when constructing/controlling/managing the physical networks based on the service-type language model or providing services based on the physical network, a network control structure and method that may minimize operator intervention between the service-type language model and the control plane of the physical network are required.

### SUMMARY OF THE INVENTION

The present invention is directed to providing an apparatus and method for network control using a language model introduced into a network control plane which, to introduce an intelligence function into physical network construction, control, management, etc. based on a language model, may overcome various issues that may occur due to different hardware-dependent control methods (e.g., network equipment specifications, complex control instructions, etc. based on domain information and characteristics) while constructing the physical network and minimize operator intervention.

In addition, the present invention is directed to providing an easy operation method of setting/controlling/managing a physical network by providing a language model pluggable device between a language model and a network (control plane/data plane) to control/manage applications and hardware abstraction blocks in a control plane at a high level based on a language model response.

In addition, the present invention is directed to providing an apparatus and method for network control capable of obtaining a response suitable for hardware-dependent network control from a language model by extracting meaningful entity identification information from natural language when an operator writes a network control request in the natural language, converting the extracted meaningful entity identification information into a single text prompt that may be understood by the language model, and setting parameter values necessary for text generation control.

In addition, an apparatus for network control according to the present invention queries a database using entity-specific information obtained from an entity extraction model when there is the entity extraction model in extracting meaningful entity identification information from natural language. When there is no entity extraction model, the control device performs all data queries determined to be related to a natural language request without separate natural language analysis, thereby querying data more delicately and accurately through appropriate responses depending on the presence or absence of an entity extraction model.

In addition, the present invention is directed to providing an apparatus and method for network control capable of minimizing operator intervention in setting instructions necessary for network control/management by converting a set (e.g., command line interface (CLI), Representational state transfer application programming interface (RestAPI), etc.) of network control instructions included in a language model response into a format that may be understood by an actual network controller of a control plane and transmitting the set of network control instructions to the network controller.

In addition, the present invention is directed to providing an apparatus and method for network control which, in collecting data with different control methods depending on hardware (e.g., network equipment specifications and complex control instructions based on domain information and domain characteristics), may pre-process data by classifying the collected data into batch data that is accumulated to a certain extent and has meaningful data value as statistical characteristics (e.g., average and standard deviation) and streaming data that requires real-time reflection.

In addition, the present invention is directed to providing a method and apparatus for reconstructing physical network capable of classifying collected data into meaningful batch data as statistical characteristics (e.g., average and standard deviation) and streaming data changing in real-time by being synchronized with a current state of the physical network, managing collected network information by separating the collected network information into unstructured data (text chunks) and structured data that may use values for each field as they are, thereby providing services by reflecting real-time network conditions even when unexpected network issues occur.

In addition, the present invention is directed to providing a method for generating a workflow containing procedures necessary for providing network services based on a natural language request from an operator and obtaining a response from a language model for each action item to implement desired settings for each network service according to a workflow procedure.

Objects of the present invention are not limited to the above-described objects. That is, other objects that are not described may be apparently understood by those skilled in the art based on the following specification.

A method of network control according to an embodiment of the present invention is a method of controlling a physical network.

The method of network control for controlling a physical network includes: receiving, by a network control command generation device, a network control request message from an operator; obtaining, by the network control command generation device, an entity search result related to the network control request message from a database storing network information on the physical network; generating, by the network control command generation device, a prompt to be input to a language model based on the entity search result, and inputting the prompt to the language model to obtain a language model response text from the language model; and generating, by the network control command generation device, a network control command based on the language model response text.

A network control command generation device according to an embodiment of the present invention is a device generating a network control command for controlling a physical network.

The network control command generation device includes a memory configured to store computer-readable commands; and at least one processor configured to execute the commands.

The at least one processor is, based on executing the commands, configured to receive a network control request message from an operator, obtain an entity search result related to the network control request message from a database storing network information on the physical network, generate a prompt to be input to a language model based on the entity search result, input the prompt to the language model to obtain a language model response text from the language model, and generate a network control command based on the language model response text.

### BRIEF DESCRIPTION OF THE DRAWINGS

The above and other objects, features, and advantages of the present invention will become more apparent to those of ordinary skill in the art by describing exemplary embodiments thereof in detail with reference to the accompanying drawings, in which:

FIG. 1 is a block diagram illustrating a configuration of a network control system according to an embodiment of the present invention;

FIG. 2 is a block diagram illustrating functions of each component of the network control system according to an embodiment of the present invention;

FIG. 3 is a block diagram for describing a function of a network assistant 110 according to an embodiment of the present invention;

FIG. 4 is a diagram for describing a message conversion function of a context analyzer 111 of the network assistant 110 according to an embodiment of the present invention;

FIG. 5 is an exemplary diagram of a network control request message input by an operator and an entity information message and an entity information query generated by converting the network control request message;

FIG. 6 is an exemplary diagram of an entity search result;

FIG. 7 is an exemplary diagram of a prompt;

FIG. 8 is an exemplary diagram of a text prompt combined with a response generation control parameter of a language model;

FIG. 9 is an exemplary diagram of a response text (language model response text) received from a language model;

FIG. 10 is an exemplary diagram of network control information;

FIG. 11 is an exemplary diagram of a network control command reconfigured to fit a network control interface;

FIG. 12 is a block diagram for describing a function of a network information collector 120 and a function of an apparatus 200 for network control for controlling a physical network 20;

FIG. 13 is a flowchart for describing a process in which the network assistant 110 generates a text prompt M340 combined with the response generation control parameter for the language model 30 based on a network control request message M310;

FIG. 14 is a flowchart for describing a process in which the network assistant 110 generates a network control command M370 based on a language model response text M350 and transmits the network control command M370 to the apparatus 200 for network control, and the apparatus 200 for network control controls the physical network 20 based on the network control command M370;

FIG. 15 is a flowchart for describing a process in which the network assistant 110 searches a vector database (DB) 115a and a relational DB 115b to combine the extracted information and generate an entity search result M320;

FIG. 16 is a flow chart for explaining the process in which the network assistant 110 generates the network control command M370 and transmits the generated network control command M370 to the apparatus 200 for network control, and receives acknowledgement (ACK) from the apparatus 200 for network control;

FIG. 17 is a flowchart for describing a process in which the network information collector 120 collects various types of network information by being synchronized with the current state of the physical network 20;

FIG. 18 is a flowchart for describing a process in which an information manager 112 stores aggregated network information in a database 115;

FIG. 19 is a block diagram illustrating a configuration of a computer system for performing a method of network control according to an embodiment of the present invention; and

FIG. 20 is a flowchart for describing the method of network control according to an embodiment of the present invention.

### DETAILED DESCRIPTION OF EXEMPLARY EMBODIMENTS

The present invention relates to an intelligence function based on an artificial intelligence language model for control and management of network elements (e.g., optical line terminal (OLT), optical network terminal (ONT), optical network unit (ONU), etc. of an optical access network) separated into a data plane and a control plane. In other words, the present invention relates to an apparatus and method for controlling and managing a complex physical network using an artificial intelligence language model.

The apparatus and method for network control according to the present invention may utilize a service-type artificial intelligence language model or an artificial intelligence language model tuned and hosted by itself for control and management of a physical network. Here, the service-type artificial intelligence language model refers to an artificial intelligence language model provided as services by such as Open AI, Anthropic, and Google.

More specifically, the present invention relates to an apparatus to which a language model is pluggable and a method for network control that generates a prompt to be input to a language model based on network information related to network control and management extracted from an operator's simple control request text composed of natural language, and converts an output (response) of the language model into a network control message (e.g., command line interface (CLI), Representational state transfer application programming interface (Restful API), etc.) and transmits the network control message to a control plane of a network, thereby enabling the setting, management, and service provision of a data plane without the operator's complex network control command.

Advantages and features of the present invention and methods to achieve them will be elucidated from exemplary embodiments described below in detail with reference to the accompanying drawings. However, the present invention is not limited to exemplary embodiments disclosed below, but will be implemented in various forms. The exemplary embodiments of the present invention make disclosure of the present invention thorough and are provided so that those skilled in the art can easily understand the scope of the present invention. Therefore, the present invention will be defined by the scope of the appended claims. Meanwhile, terms used in the present specification are for explaining exemplary embodiments rather than limiting the present invention. Unless otherwise stated, a singular form includes a plural form in the present specification. Components, steps, operations, and/or elements mentioned by terms “comprise” and/or “comprising” used in the present disclosure do not exclude the existence or addition of one or more other components, steps, operations, and/or elements.

Terms used in the specification, “first”, “second”, etc. can be used to describe various components, but the components are not to be construed as being limited to the terms. These terms may be used to differentiate one component from other components. For example, a first component may be named a second component, and the second component may also be similarly named the first component, without departing from the scope of the present disclosure.

It is to be understood that when one element is referred to as being “connected to” or “coupled to” another element, it may be connected directly to or coupled directly to another element or be connected to or coupled to another element by having still another element intervening therebetween. On the other hand, it should be understood that when one element is referred to as being “connected directly to” or “coupled directly to” another element, it may be connected to or coupled to another element without still another element interposed therebetween. In addition, other expressions describing a relationship between components, that is, “between,” “directly between,” “neighboring to,” “directly neighboring to,” and the like, should be similarly interpreted.

When it is decided that a detailed description of the known art related to the present invention may unnecessarily obscure the gist of the present invention, the detailed description therefor will be omitted.

Hereinafter, embodiments of the present disclosure will be described in detail with reference to the accompanying drawings. The same means will be denoted by the same reference numerals throughout the accompanying drawings in order to facilitate the general understanding of the present invention in describing the present invention.

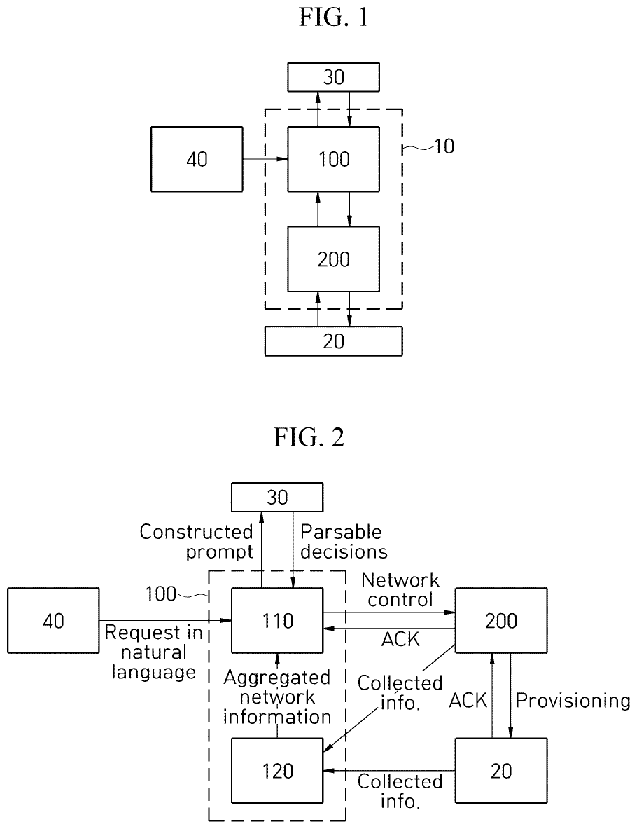

FIG. 1 is a block diagram illustrating a configuration of a network control system 10 according to an embodiment of the present invention. The network control system 10 is designed to introduce an intelligence function based on a language model (LM) for constructing, controlling, or managing a physical network 20.

As illustrated in FIG. 1, the network control system 10 includes a network control command generation device 100 and an apparatus 200 for network control. The network control system 10 generates a prompt based on a network control request message M310 received from an operator 40 and network information collected from the physical network 20. The network control system 10 inputs the prompt to a language model 30 that is built-in or exists in an external server. The network control system 10 generates a network control command M370 based on a language model response text M350 received from the language model 30 and controls a control plane and a data plane of the physical network 20 by applying the network control command M370.

As illustrated in FIG. 1, the network control system 10 is connected to the physical network 20, an artificial intelligence-based language model 30 built into the network control system 10 or existing in an external server, and the operator 40. The operator 40 inputs the network control request message M310 in natural language to the network control system 10 to request network control. The network control command generation device 100 converts the network control request message M310 to generate a prompt that may be input to the language model 30. The language model 30 receives the prompt from the network control command generation device 100 and outputs the language model response text M350, which is a decision in a parsable form. The network control command generation device 100 extracts network control information M360 from the language model response text M350, generates the network control command M370 based on the network control information M360, and transmits the generated network control command M370 to the apparatus 200 for network control. The apparatus 200 for network control controls or manages the physical network 20 using the network control command M370. That is, the apparatus 200 for network control controls the data plane through the network control plane based on the parsed decision.

As described above, the language model 30 may be a service-type language model (e.g., generative pre-trained transformer (GPT), Gemini, Claude, etc.) or a fine-tuned local language model.

As described above, the network control command generation device 100 is a device that generates the network control command M370 for controlling the physical network 20, and is a device for introducing intelligence functions for physical network construction/control/management, etc. based on the language model 30.

The network control command generation device 100 includes a memory storing computer-readable commands and at least one processor implemented to execute the commands.

The at least one processor is configured to receive the network control request message M310 from the operator 40 by executing the commands, obtain an entity search result M320 related to the network control request message M310 from a database 115 storing network information on the physical network 20, generate a prompt M332 or M340 to be input to the language model 30 based on the entity search result M320, input the prompt M332 or M340 into the language model 30 to obtain the language model response text M350 from the language model 30, and generate the network control command M370 based on the language model response text M350.

In an embodiment of the present invention, the at least one processor is configured to, in the process of obtaining the entity search result M320, generate an entity information query M312 based on the network control request message M310 and input the entity information query M312 to the database to obtain the entity search result M320.

In an embodiment of the present invention, the at least one processor is configured to, in the process of obtaining the entity search result M320, extract meaningful information included in the network control request message M310 using an entity extraction model, generate an entity information message M311 including one or more field name-field value pair data based on the meaningful information, define each field name-field value pair data included in the entity information message M311 as a lookup entity to generate the entity information query M312, and input the entity information query M312 to the database 115 to obtain the entity search result M320.

In an embodiment of the present invention, the at least one processor is configured to generate the prompt M332 by reconstructing the message combining the network control request message M310 and the entity search result M320 into a text prompt format during the process of obtaining the language model response text M350.

In an embodiment of the present invention, the at least one processor is configured to, in the process of obtaining the language model response text M350, reconstruct the message combining the network control request message M310 and the entity search result M320 into the text prompt format and to add a parameter that controls a response generation of the language model 30 to generate the prompt M340.

In an embodiment of the present invention, the at least one processor is configured to, in the process of generating the network control command M370, extract the network control information M360 included in the language model response text M350 by parsing the language model response text M350 and reconstruct the network control information M360 to fit the network control interface of the physical network 20 in order to generate the network control command M370.

In an embodiment of the present invention, the network control interface may be any one of the CLI and the RestAPI.

In an embodiment of the present invention, the at least one processor is configured to collect network information in the form of raw data from the physical network 20 and metadata about the network information, pre-process the network information, and store the pre-processed network information in the database 115.

In an embodiment of the present invention, the at least one processor is configured to perform one or a combination of organization, transformation, labeling, and feature extraction of the network information during the process of pre-processing the network information.

In an embodiment of the present invention, the at least one processor is configured to determine, based on the metadata, which database of the relational database 115b and the vector database 115a the pre-processed network information will be stored in during the process of storing the pre-processed network information in the database 115.

Hereinafter, the functional configuration of the network control command generation device 100 according to an embodiment of the present invention will be described.

FIG. 2 is a block diagram illustrating the functions of each component of the network control system 10 according to an embodiment of the present invention. As illustrated in FIG. 2, the network control command generation device 100 may include a network assistant 110 and a network information collector 120.

The network information collector 120 collects various types of information (hereinafter, “network information”) necessary for the language model 30 to make a decision from the apparatus 200 for network control and the physical network 20 by being synchronized with the current state of the physical network 20. The network information may include specifications of devices connected to the physical network 20, network policies applied to the physical network 20, and topologies of the physical network 20. The network information collector 120 collects network information from the apparatus 200 for network control and the physical network 20, pre-processes the collected network information, and transmits the pre-processed network information to the network assistant 110. The network assistant 110 stores the network information in internal storage.

The operator 40 may make a network control request to the network assistant 110 in the natural language. That is, the operator 40 may transmit or input the network control request message M310 to the network assistant 110. The network assistant 110 generates a prompt corresponding to the network control request message M310 of the operator 40 based on pre-stored network information and transmits the prompt to the language model 30. The language model 30 outputs a decision in a parsable form that may process the request of the operator 40, that is, the language model response text M350. The network assistant 110 generates the network control command M370 based on the language model response text M350 and transmits the network control command M370 to the apparatus 200 for network control. The apparatus 200 for network control may provide provisioning of the physical network 20 according to the request of the operator 40 based on the network control command M370.

The network control system 10 including the network control command generation device 100 and the apparatus 200 for network control, to provide the intelligence functions for constructing/controlling/managing the physical network 20, may overcome various issues that may occur due to different hardware-dependent control methods (e.g., domain information and network equipment specifications, complex control instructions, etc. according to domain characteristics) while constructing the physical network 20, and may minimize the intervention of the operator 40.

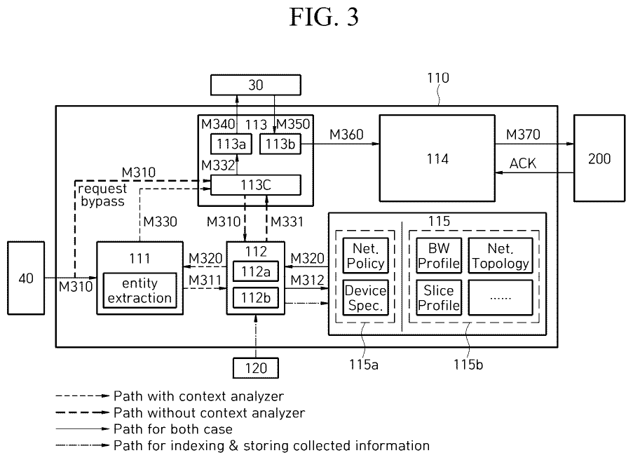

FIG. 3 is a block diagram for describing the functions of the network assistant 110.

The network assistant 110 may include a context analyzer 111, an information manager 112, an AI orchestrator 113, a network control message generator 114, and the database 115.

The context analyzer 111 may receive the network control request message M310, which is a control request message of the operator 40 composed of natural language, from the operator 40 and may extract various types of meaningful information inherent in the network control request message M310 by utilizing the entity extraction model.

When the context analyzer 111 is not included in the network assistant 110 or the function of the context analyzer 111 is not used by setting, the network assistant 110 may process the network control request message M310 by bypassing the network control request message M310 to the prompt constructor 113c included in the AI orchestrator 113 without a separate natural language analysis process.

When the network assistant 110 includes the context analyzer 111 and utilizes the function of the context analyzer 111 by setting, the context analyzer 111 applies the entity extraction model to the network control request message M310 to generate the entity information message M311. The context analyzer 111 transmits the entity information message M311 to the information manager 112.

When receiving the entity information message M311, the information manager 112 generates the entity information query M312 based on the entity information message M311 through the search unit 112a. The information manager 112 transmits the entity information query M312 to the database 115 to obtain information on each entity included in the entity information message M311. That is, the information manager 112 queries information on each entity among the network information stored in the database 115a and 115b through the search unit 112a to obtain the entity search result M320.

When the context analyzer 111 does not have a function or the context analyzer 111 is not used by setting, the information manager 112 receives the network control request message M310, which is a natural language request from the operator 40, as it is from the prompt constructor 113c of the AI orchestrator 113. Based on the network control request message M310, the information manager 112 may query data that is determined to be related to the network control request message M310 from all databases included in the database 115.

When the network control request message M310 passes through the context analyzer 111, a granular database query is made possible, so the information manager 112 may obtain finer-grained and accurate data from the database 115.

When the context analyzer 111 is utilized, the information manager 112 transmits the entity search result M320 obtained from the database 115 to the context analyzer 111, and the context analyzer 111 transmits a message M330 combining the network control request message M310 and the entity search result M320 to the prompt constructor 113c of the AI orchestrator 113.

When the context analyzer 111 is not utilized, the information manager 112 generates the entity information query M312 based on the network control request message M310 and obtains the entity search result M320A from the database 115 using the generated entity information query M312. The information manager 112 transmits a message M331 that combines the network control request message M310 and the entity search result M320A to the prompt constructor 113c.

The prompt constructor 113c generates a single text prompt M332 that may be understood by the language model 30 based on the network control request message M310 in the natural language and the entity search result M320 or M320A of the database 115 and transmits the prompt to the request transmission unit 113a.

The request transmission unit 113a generates an updated prompt M340 by combining a parameter and its value (hereinafter referred to as a “response generation control parameter”) that controls the response generation of the language model 30 with the prompt M332. That is, the request transmission unit 113a generates the prompt M340 to be input to the language model 30 by combining the response generation control parameter with the text prompt M332. The response generation control parameter is a parameter that controls the text generation method of the language model 30 and serves to limit, for example, the creativity of the language model 30 or the number of output tokens. The value of the response generation control parameter may be a preset value or may be determined by the operator 40.

The request transmission unit 113a transmits the prompt M340 combined with the response generation control parameter for the language model 30 to the language model 30, and the response parsing unit 113b receives the language model response text M350 output by the language model 30. The language model response text M350 is a text message output by the language model 30 in response to the prompt M340. As another example, the request transmission unit 113a may transmit the prompt M332 received from the prompt constructor 113c to the language model 30 instead of generating the prompt M340 combined with the response generation control parameter. In this case, the response parsing unit 113b receives the language model response text M350 generated by the language model 30 in response to the prompt M332 with which the response generation control parameter is not combined.

The response parsing unit 113b parses the language model response text M350, extracts the network control information M360 from the language model response text M350, and transmits the extracted network control information to the network control message generator 114.

The network control information M360 is information to be included in the actual network control command M370. The network control information M360 may be data structured in an object grammar (e.g., JavaScript Object Notation (JSON), Extensible Markup Language (XML), etc.). That is, the network control information M360 may be data according to a format such as JSON or XML. For this purpose, the text prompt M332 may include a command indicating a data format to be output by the language model 30.

The network control message generator 114 converts the network control information M360, which is the result of parsing the language model response text M350, into a format that may be recognized by the apparatus 200 for network control and generates the network control command M370. That is, the network control command M370 may be generated based on a control instruction set (e.g., CLI, RestAPI payload, etc.) that the apparatus 200 for network control may recognize. The network control message generator 114 transmits the network control command M370 to the apparatus 200 for network control so that the apparatus 200 for network control may complete the request of the operator 40.

Meanwhile, the information manager 112 may receive the aggregated network information (aggregated network information) collected by the network information collector 120. In the present invention, aggregated network information represents information that the network information collector 120 pre-processes the information collected from the apparatus 200 for network control and the physical network 20.

The indexing unit 112b divides the aggregated network information into structured data and unstructured data, indexes each of the divided data, and then stores the indexed structured data and unstructured data in the database 115. In this embodiment, the database 115 includes a vector DB 115a and a relational DB 115b.

The indexing unit 112b indexes the aggregated network information (e.g., equipment specification information) when the aggregated network information is the structured data (e.g., data in JSON or XML format) and stores the aggregated network information in the relational DB 115b. When the aggregated network information has the structured data (e.g., JSON format) characteristic indexed as a field, the indexing unit 112b may store values for each field as they are in the relational DB 115b depending on the setting.

In addition, the indexing unit 112b determines that the aggregated network information (e.g., PDF) rather than the structured data (e.g. JSON and XML format data) is the unstructured data. In this case, the aggregated network information is indexed as a vector value of the aggregated network information and stored in the vector DB 115a.

In order to store the unstructured data (e.g., text chunk) in the vector DB 115a, the indexing unit 112b divides the text included in the unstructured data into chunks, which are partial units, calculates a vector value for a partial string included in each chunk, and sets the calculated vector value as an index. The indexing unit 112b stores the indexed unstructured data as described above in the vector DB 115a.

The network control system 10 including the above-described network assistant 110 and the network information collector 120 extracts an entity search result M320 or M320A, which is meaningful entity identification information, from the database 115 based on the network control request message M310 of the operator 40. Subsequently, the network control system 10 combines the network control request message M310 and the entity search result M320 or M320A to generate the single text prompt M332 or M340 that may be understood by the language model 30. Then, the network control system 10 inputs the prompt M332 or M340 to the language model 30 and obtains the language model response text M350 that matches the request of the operator 40 from the language model 30. The network control system 10 may provide an intelligent network control/management function by generating the network control command M370 in a format (e.g., CLI, RestAPI, etc.) that may be recognized by the actual apparatus 200 for network control of the control plane based on the language model response text M350 and transmitting the generated network control command M370 to the apparatus 200 for network control.

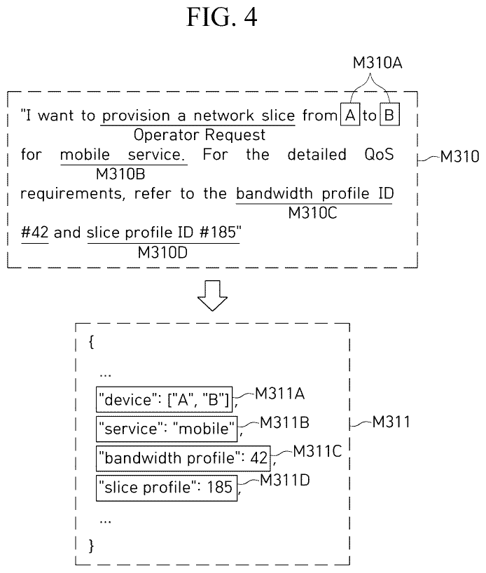

FIG. 4 is a diagram for describing a message conversion function of the context analyzer 111 of the network assistant 110 according to an embodiment of the present invention. That is, FIG. 4 is a diagram illustrating a function of the context analyzer 111 according to an embodiment of the present invention in the message conversion format.

When receiving the network control request message M310 composed of natural language from the operator 40, the context analyzer 111 may extract one or more meaningful pieces of information (e.g., M310A, M310B, M310C, and M310D of FIG. 4) included in the network control request message M310 and generate the entity information message M311 message based on the extracted meaningful information. In the example of FIG. 4, M310A is device information, M310B is service information, M310C is bandwidth profile information, and M310D is slice profile information. For example, the context analyzer 111 converts the meaningful information M310A, M310B, M310C, and M310D into data M311A, M311B, M311C, and M311D in the form of [field name: field value], merges the converted data, and generates the entity information message M311 that follows the JSON format and is composed of a plurality of [field name: field value]. The number of field name-field value pair data M311A, M311B, . . . included in the entity information message M311 may vary depending on the number of pieces of meaningful information included in the network control request message M310. In the present invention, each of the field name-field value pair data M311A, M311B, . . . is defined as a single lookup entity, and each feature (e.g., “A,” “B,” “mobile,” 42, 185 in FIG. 4) included in the field value may be defined as an individual token for the corresponding field (e.g., “device,” “service,” “bandwidth profile,” “slice profile” in FIG. 4).

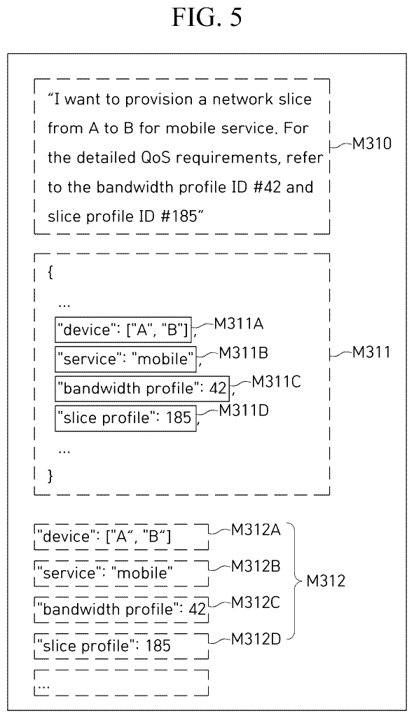

FIG. 5 is an exemplary diagram of a network control request message input by the operator and an entity information message and an entity information query generated by converting the network control request message.

As described above, the network control request message M310 is the network control request message of the operator 40 composed in the natural language. The entity information message M311 of FIG. 5 is a message in which the context analyzer 111 extracts various types of meaningful information embedded in the natural language from the network control request message M310 and expresses entities identified and extracted from the meaningful information as a list of [field name: field value] in the JSON format. In addition, the entity information query M312 is a message in which entities included in the entity information message M311 are expressed as individually identified lookup entities M312A, M312B, M312C, and M312D in order for the information manager 112 to obtain information on the entities from the database 115.

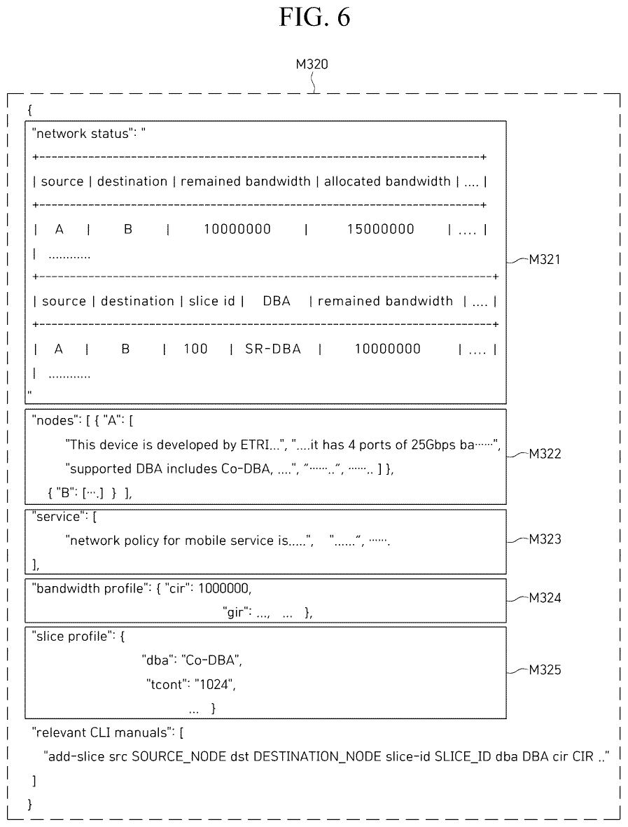

FIG. 6 is an exemplary diagram of the entity search result.

The entity search result M320 is a message obtained by the information manager 112 by inputting the entity information query M312 as the lookup entity to the database 115.

As described above, the context analyzer 111 generates the entity information message M311 based on the network control request message M310, and the information manager 112 performs a message conversion process to generate the entity information query M312 based on the entity information message M311. The information manager 112 uses the entity information query M312 message as the lookup entity and uses the message obtained from the database 115 as the entity search result M320.

Meanwhile, when the context analyzer 111 function is not used or the context analyzer 111 does not exist, the network assistant 110 transmits the network control request message M310 input from the operator 40 to the information manager 112 through the prompt constructor 113c via a bypass. In this case, the information manager 112 uses the network control request message M310 as the lookup entity to obtain the entity search result M320A from the database 115. Since the entity search result M320A has the same message format as the entity search result M320, the entity search result M320A is not illustrated in the drawing. For reference, letters A, B, C, D, . . . behind the reference symbols of the entity information message M311 and the entity information query M312 in FIG. 5 mean that they have the same message format, but their contents may be different.

When the context analyzer 111 function is used, the context analyzer 111 transmits the message M330 that combines the network control request message M310 and the entity search result M320 obtained from the database 115 to the prompt constructor 113c.

When the context analyzer 111 function is not used, the information manager 112 transmits the message M331 that combines the network control request message M310 and the entity search result 320A obtained from the database 115 to the prompt constructor 113c.

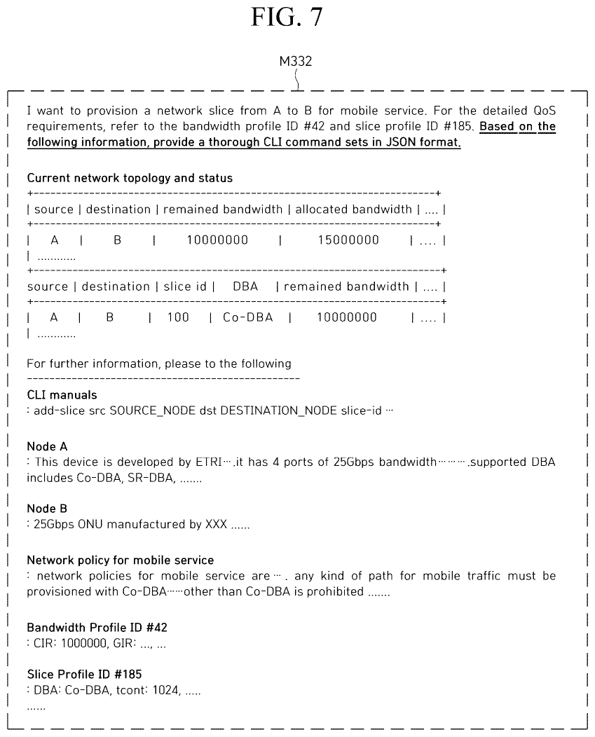

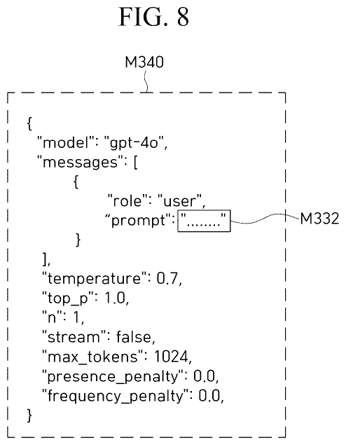

FIG. 7 is an exemplary diagram of the text prompt, and FIG. 8 is an exemplary diagram of the text prompt in which the response generation control parameters of the language model are combined.

The prompt constructor 113c reconstructs the message M330 or M331 that is a combination of the network control request message M310 and the entity search result M320 or M320A into the text prompt format to generate the prompt M332. FIG. 6 illustrates an example of the prompt M332.

The request transmission unit 113a generates the prompt M340 as illustrated in FIG. 8 by combining the response generation control parameter for the language model 30 with the prompt M332.

The prompt M340 illustrated in FIG. 8 has a message detail structure in which parameters (e.g., model name, temperature, top p, max tokens, top k, . . . ) that control the response generation of the language model 30 are combined with the prompt M332 generated by the prompt constructor 113c. As illustrated in FIG. 8, the prompt M340 may include the prompt M332.

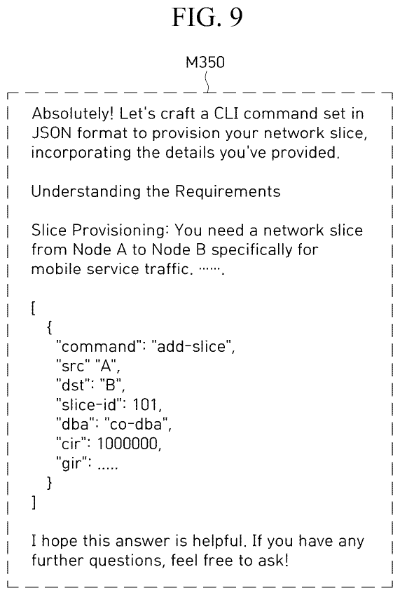

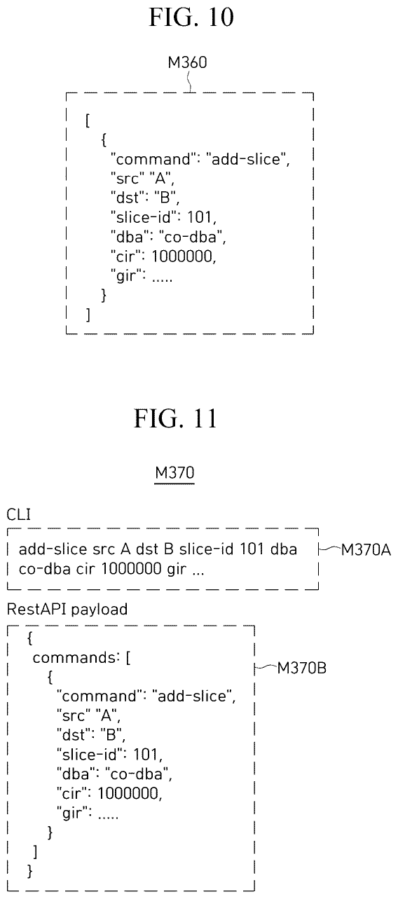

FIG. 9 is an exemplary diagram of the language model response text, FIG. 10 is an exemplary diagram of the network control information, and FIG. 11 is an exemplary diagram of the network control command.

As described above, the language model response text M350 is a text message that the language model 30 outputs in response to receiving the prompt M332 or M340. The response parsing unit 113b receives the language model response text M350 from the language model 30, extracts the control information identified by parsing the language model response text M350, generates the network control information M360, and transmits the network control command M360 to the network control message generator 114. The network control message generator 114 reconfigures the network control information M360 to fit the network control interface (e.g., converts the network control command M370 into a CLI direct input format or a RestAPI payload, etc.), generates the network control command M370, and transmits the generated network control command M370 to the apparatus 200 for network control.

In FIG. 11, the network control command M370A is the control command according to the CLI direct input format, and the network control command M370B is the control command in the form of the RestAPI payload.

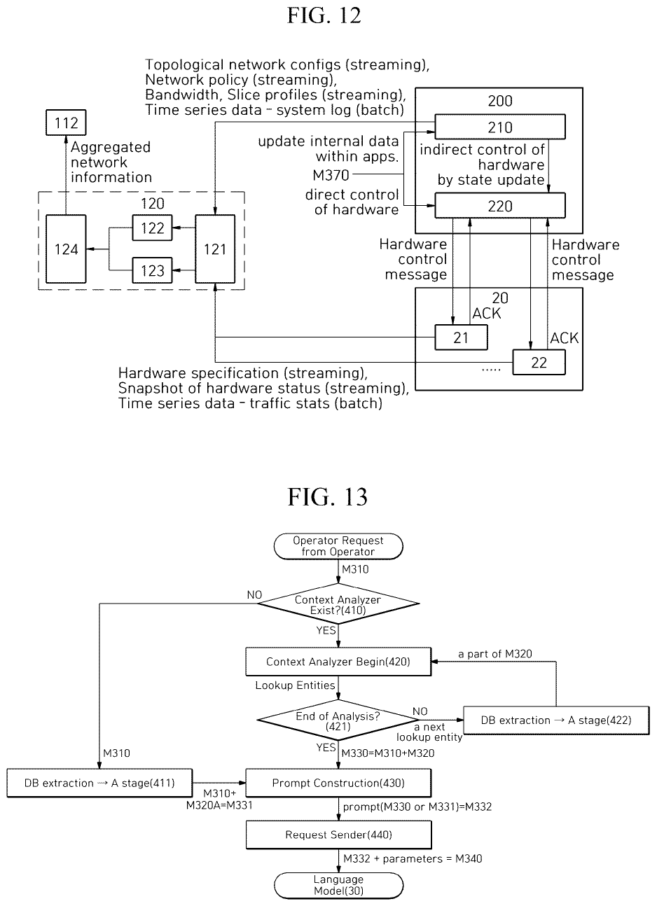

FIG. 12 is a block diagram for describing the function of the network information collector 120 and the function of the apparatus 200 for network control for controlling the physical network 20.

The network information collector 120 obtains various types of network information (e.g., device specifications, network policies, topologies, etc.) necessary for the language model 30 to make a decision from the physical network 20 by being synchronized with the current state of the physical network 20, and synthesizes various types of network information to generate the aggregated network information and transmits the aggregated network information to the network assistant 110.

The network information collector 120 may include a classifier 121, a batch data receiver 122, a streaming data receiver 123, and a data pre-processor 124.

The classifier 121 collects raw data from a management app 210 installed in the apparatus 200 for network control and multiple vendor-specific agents 21, 22, . . . within the physical network 20. The vendor-specific agents 21, 22, . . . may be hardware installed in a device connected to the physical network 20 or may be software modules run on a processor included in the connected device.

The classifier 121 classifies the raw data into either batch data or streaming data and transmits the raw data to either the batch data receiver 122 or the streaming data receiver 123 based on the classification result. That is, the classifier 121 transmits the raw data classified as the batch data to the batch data receiver 122 and transmits raw data classified as the streaming data to the streaming data receiver 123.

The batch data receiver 122 receives the raw data from the classifier 121 in a preset batch unit (minimum batch size). The queue of the batch data receiver 122 has a size larger than the batch unit. In the present invention, the batch data is data that is not real-time data and is meaningful data when accumulated to a predetermined size or larger. For example, the average or standard deviation is the batch data. The meaningful accumulated size of the batch data may be determined according to the type of batch data. When the batch data larger than the preset size is accumulated in the queue of the batch data receiver 122, the batch data receiver 122 transmits the batch data of the preset size to the data pre-processor 124, and the data pre-processor 124 pre-processes the received batch data.

The streaming data receiver 123 receives the raw data classified as the streaming data from the classifier 121. For example, the streaming data may be data that changes in real time. The streaming data receiver 123 may immediately transmit the received streaming data to the data pre-processor 124.

The data pre-processor 124 pre-processes the raw data received from the batch data receiver 122 or the streaming data receiver 123. Before the raw data is stored in the database 115, the data pre-processor 124 may perform tasks such as cleaning, transformation, and labeling of the raw data or feature extraction by applying a feature engineering technique to the raw data.

The raw data collected by the classifier 121 from the management app 210 installed in the apparatus 200 for network control may include, for example, topological network configurations (streaming), network policies (streaming), bandwidth profiles (streaming), slice profiles (streaming), and time series data-system log (batch).

Examples of the raw data collected by the classifier 121 from the vendor-specific agents 21, 22, . . . may include, for example, hardware specifications (streaming), snapshots of hardware status (streaming), and time series data-traffic status (batch).

A scheme (i.e., type of raw data-batch or streaming) of receiving raw data and a type of databases 115a or 115b in which the raw data is stored after being pre-processed are independent of each other. That is, the scheme (the type of raw data) of receiving the raw data does not determine the type of database 115a or 115b in which the raw data is stored. For example, the data received by the batch data receiver 122 may be stored in the relational DB 115b or the vector DB 115a, and the data received by the streaming data receiver 123 may similarly be stored in the relational DB 115b or the vector DB 115a.

Meanwhile, the management app 210 installed in the apparatus 200 for network control is composed of applications for controlling/managing the entire physical network 20 at a high level and may perform functions such as network slice policy management, physical network topology management, network slice topology management, subscriber authentication management, subscriber flow installation, and flow control/management.

The hardware provisioning app 220 installed in the apparatus 200 for network control is an application for abstracting and controlling multiple physical hardware. Depending on the degree of abstraction of the physical hardware, the hardware provisioning app 220 may include only a simple interface or may include functions such as a state machine that have traditionally been implemented in physical hardware devices.

As illustrated in FIG. 12, when the network control command M370 is transmitted to the apparatus 200 for network control, if an update of the operation data of an application installed in the apparatus 200 for network control is required, the management app 210 processes the update and then indirectly controls the hardware provisioning app 220 through a status update to transmit the control message to the physical network 20. In addition, when the network control command M370 is a message that allows direct control of the physical network 20, the hardware provisioning app 220 of the apparatus 200 for network control that receives the network control command may directly transmit the network control command M370 to the physical network 20 to control the physical network 20.

The vendor-specific agents 21, 22, . . . of the physical network 20 may provide an interface that may interact with the hardware provisioning app 220 and may include a device that translates decisions (e.g., path setting, slice setting, etc.) made by the apparatus 200 for network control into an instruction set that may be understood by the physical hardware device.

Hereinafter, with reference to FIGS. 13 to 16, a method of generating a network control command using a language model according to an embodiment of the present invention will be described. The network control command generation method is performed by the network assistant 110. FIGS. 13 to 16 illustrate an overall operation flow diagram in which, when the operator 40 makes the network control request in the natural language, the network control system 10 adds pre-processed network information to the prompt and transmits the prompt to the language model 30 so that the language model 30 may process the operator request, and when the language model 30 returns the decision in the parsable form, the physical network 20 is controlled through the apparatus 200 for network control based on the parsed decision.

FIG. 13 is a flowchart for describing the process of generating the text prompt M340 combined with the response generation control parameter for the language model 30 based on the network control request message M310 by the network assistant 110.

First, the network assistant 110 receives the network control request message M310 in the natural language from the operator 40. The network assistant 110 checks whether the context analyzer 111 exists and whether the context analyzer 111 is used (if present) (410). When the context analyzer 111 exists and is used, the network assistant 110 performs operation 420, and when the context analyzer 111 does not exist or is not used, the network assistant 110 performs operation 411.

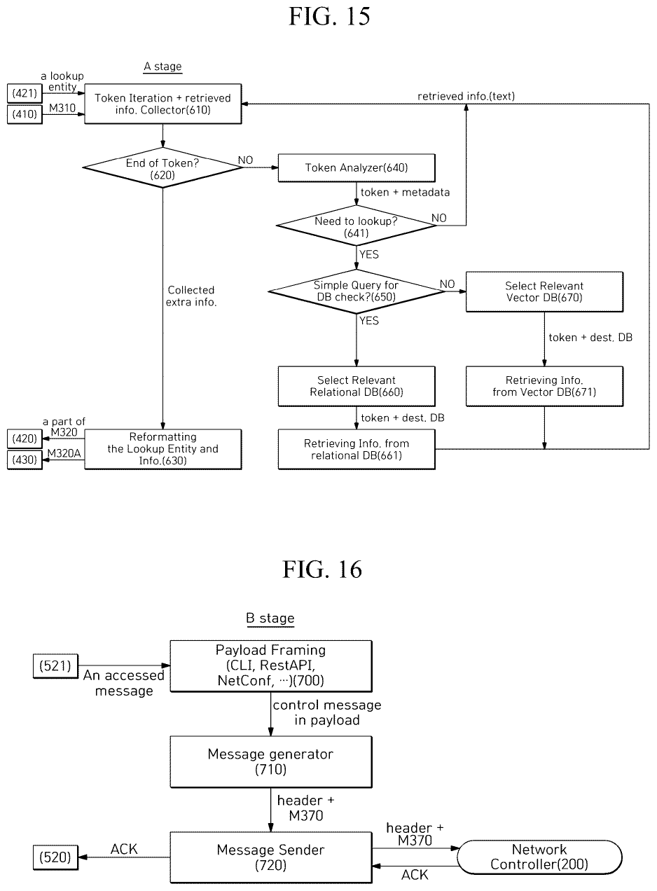

In operation 411, the network assistant 110 extracts an entity search result 320A from the database 115 using the entire network control request message M310 as the lookup entity (see operation A of FIG. 15 for specific details).

In operation 430 performed after operation 411, the network assistant 110 generates the message M331 that combines the network control request message M310 and the entity search result message M320A and generates the prompt M332 based on the message.

In operation 420, the context analyzer 111 extracts one or more pieces of meaningful information inherent in the network control request message M310 in the natural language to generate the lookup entity list 420 and determines whether analysis of all lookup entities is completed (421).

When the analysis of all lookup entities is not completed, the network assistant 110 performs operation A 422 of extracting a part of the entity search result 320 by transmitting one lookup entity in the next order to the database 115. Until the analysis of all lookup entity lists is completed, the network assistant 110 repeats the process of performing operation 422 (operation A) to receive a partial message of the entity search result M320 from the database 115.

When the analysis of all the lookup entities is completed, the network assistant 110 generates the message M330 that combines the network control request message M310 and the entity search result M320 and generates the prompt M332 based on the message M330 (430).

The network assistant 110 generates the prompt M340 with parameter values that may control the text generation method through the request transmission unit 113a (440) and then transmits the prompt M340 to the language model 30.

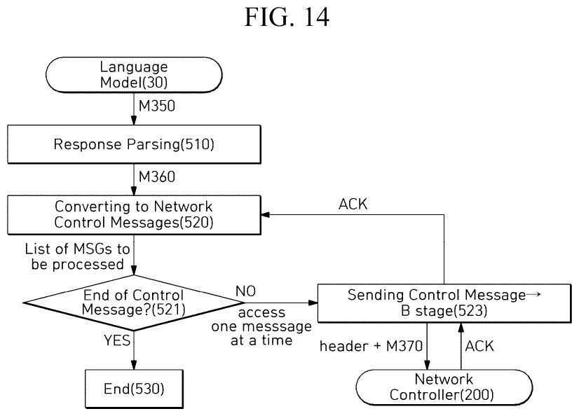

FIG. 14 is a flowchart for describing the process in which the network assistant 110 generates the network control command M370 based on the language model response text M350 and transmits the network control command M370 to the apparatus 200 for network control, and the apparatus 200 for network control controls the physical network 20 based on the network control command M370.

When the network assistant 110 receives the language model response text M350, which is a text message, from the language model 30, the response parsing unit 113b parses the language model response text M350 and extracts the network control information M360 from the language model response text M350 (510). The network control information M360 is information to be included in the actual network control command M370. The network control information M360 may be data structured in object grammar (e.g. JSON, XML, etc.).

The network control message generator 114 converts the network control information M360, which is a result of parsing the language model response text M350, into a format that may be recognized by apparatus 200 for network control and generates the network control command M370 (520). That is, the network control command M370 may be generated based on the control instruction set (e.g. CLI, RestAPI payload, etc.) that may be recognized by the apparatus 200 for network control. The network assistant 110 verifies whether all action items (control information) included in the network control information M360 have been processed (521). That is, the network assistant 110 verifies whether all control information included in the network control information M360 has been processed by the apparatus 200 for network control.

When all the action items included in the network control information M360 have been processed, the network assistant 110 completes the processing procedure for the operator's network control request message M310 (530).

When all the action items have not been processed, a B operation is performed to generate and transmit the network control command M370 for the next action item (523). In operation 523, the network control message generator 114 adds a protocol specific header suitable for various network protocols to the network control command M370 and transmits the network control command M370 to the apparatus 200 for network control. The apparatus 200 for network control transmits the acknowledgment (ACK) to the network control message generator 114 through the hardware provisioning app 220 after the processing of the corresponding command M370 in the physical network 20 is completed, and the network control message generator 114 completes the procedure for the operator request (530) when it is confirmed that the processing of all the action items is completed.

As described above, the network control system 10 generates a workflow containing the procedure required for providing a network service through the operator's natural language request and obtains the acknowledgment from the language model 30 for each action item to generate the desired settings for each network service according to the workflow procedure.

FIG. 15 is a flowchart for describing a process in which the network assistant 110 searches the vector DB 115a and the relational DB 115b and combines the extracted information to generate the entity search result M320.

In operation 410 or operation 421 of FIG. 13, the network assistant 110 sets the network control request message M310 as the lookup entity or performs the token iteration based on the lookup entity included in the entity information message 311 derived from the network control request message M310. The network assistant 110 performs operations 641 to 661 or steps 641 to 671 to collect retrieved information from the database 115 (610).

The network assistant 110 verifies the data collected from the database 115 for each token (620), and when data collection is completed for all tokens, the network assistant 110 performs reformatting of the lookup entity and the collected information (630).

When operation A of FIG. 15 starts at operation 410 of FIG. 13 (if it proceeds between 410 to 411), the reformatted entity search result M320A is transmitted to the information manager 112 and the prompt constructor 113c, and the prompt M332 generation task is performed (430).

When operation A of FIG. 15 starts at operation 421 of FIG. 13 (if it proceeds between 421 to 422), a partial message of the reformatted entity search result M320 is transmitted to the information manager 112.

In operation 620, the network assistant 110 performs token analysis when the data collection is not completed for all tokens (640) and then determines whether a lookup is necessary (641). After checking the token and metadata, in operation 641, when the lookup is not necessary, the network assistant 110 returns the input value as it is, and when the lookup is necessary, it determines whether to search in the relational DB 115b (650 ). Here, the metadata is meta information analyzed by the token analyzer for each token that is iterated in operation 640. Examples of metadata may include whether an information query for the corresponding token is necessary (Boolean), and the name of the DB to be queried (string) when the query is necessary. After operation 650, when the lookup of the relational DB 115b is selected (660), the network assistant 110 searches the relational DB 115b for the data (661) and then proceeds with operation 610, and when the lookup of the vector DB 115a is selected (670), the network assistant 110 searches the vector DB 115a (671) for the data and then proceeds with operation 610.

FIG. 16 is a flowchart for describing the process in which the network assistant 110 generates the network control command M370 and transmits the network control command M370 to the apparatus 200 for network control, and receives acknowledgment (ACK) from the apparatus 200 for network control.

The network assistant 110 extracts each action item (control information) included in the network control information M360 in operation 521 of FIG. 14 and performs payload framing to generate the network control command M370 in accordance with the corresponding protocol (CLI, RestAPI, NetConf, . . . ) (700). Then, the network assistant 110 transmits the network control command M370 with a protocol-specific header added in accordance with the network protocol to the apparatus 200 for network control (720). The apparatus 200 for network control returns the acknowledgement (ACK) to the network assistant 110 upon completion of processing of each action item.

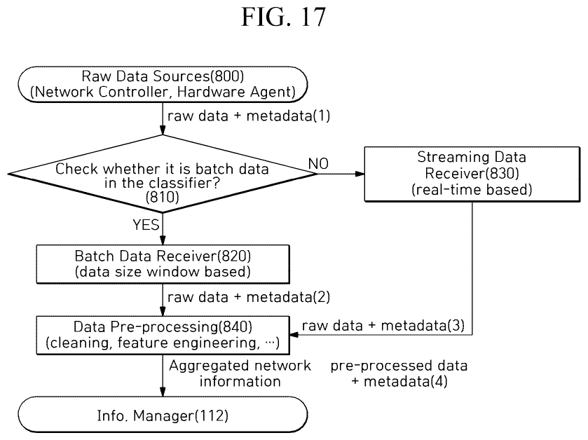

FIG. 17 is a flow chart for describing the process of the network information collector 120 collecting various types of network information by being synchronized with the current state of the physical network 20.

The network information collector 120 collects the raw data from the management app 210 installed in the apparatus 200 for network control and a number of vendor-specific agents 21, 22, . . . included in the physical network 20, and adds metadata thereto (800). The network information collector 120 determines whether the collected raw data is batch data through the classifier 121 (810).

When the raw data collected in operation 810 is classified as the batch data, the batch data receiver 122 that receives the raw data adds metadata to the raw data in batch data units based on the data size window and transmits the batch data to the data pre-processor 124 (820).

In operation 810, when the collected raw data is classified as the streaming data, the streaming data receiver 123 that receives the raw data adds the metadata in real time and transmits the raw data to the data pre-processor 124 (830).

The data pre-processor 124 performs data pre-processing tasks such as cleaning, transformation, labeling, and applying feature engineering techniques to the raw data (840), and then transmits the aggregated network information with metadata added to the pre-processed data to the information manager 112 so that the information manager 112 may store the pre-processed data in the database 115.

In the present invention, the metadata is meta information included when the raw data is transmitted from a source (the apparatus 200 for network control or the device included in the physical network 20) of the raw data to the network information collector 120. For example, the metadata may include information such as the name of the database where the collected data will be stored, data characteristics (batch or streaming), the collected location (network controller or ggent), the collected date, and the collected system information (software version, etc.). Further, in addition to the metadata exemplified above, the information on the data pre-processing pipeline/method applied to the raw data may also be added.

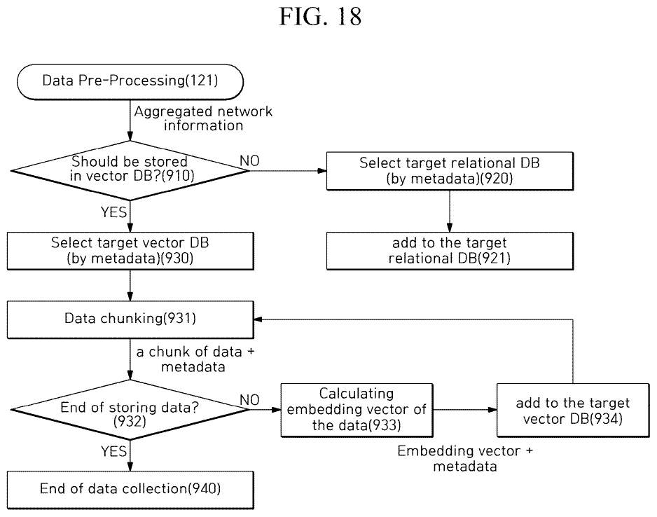

FIG. 18 is a flowchart for describing the process in which the information manager 112 stores the aggregated network information in the database 115.

When the information manager 112 receives the aggregated network information from the data pre-processor 124, the information manager 112 checks the metadata added to the aggregated network information to determine whether the aggregated network information should be stored in the vector DB 115a (910).

In operation 910, when the destination DB of the corresponding aggregated network information is selected as the database included in the relational DB 115b based on the metadata (920), the information manager 112 stores the corresponding aggregated network information in the destination DB of the relational DB 115b (921 ).

In operation 910, when the destination DB of the corresponding aggregated network information is selected as the database included in the vector DB 115a based on the metadata (930), the information manager 112 performs a data chunking task of the corresponding aggregated network information (931). The information manager 112 checks whether the last data has been stored in the database 115 (932), and when all the aggregated network information has been stored in the database 115, the data collection is terminated (940).

In operation 932, when there is more data to be stored, the information manager 112 calculates an embedding vector of each data chunk (933), stores the aggregated network information, its embedding vector, and metadata in the destination DB of the vector DB 115a (934), and repeats operation 931.

In the present invention, a batch means a minimum unit for pre-processing collected data, and a chunk means a minimum division unit of pre-processed data to be stored in the vector DB 115a. In order to store the unstructured data (text chunks) in the vector DB 115a, the information manager 112 should divide the text included in the aggregated network information, calculate an embedding vector value for each divided substring, and then set the calculated embedding vector as an index of the aggregated network information (or divided text).

A network information collection and storage method according to an embodiment of the present invention has been described through FIGS. 17 and 18. The network control command generation device 100 is synchronized with the current state of the physical network 20, and classifies the raw data (network information) collected from the apparatus 200 for network control and the physical network 20 into meaningful batch data with statistical characteristics (e.g., average and standard deviation) when accumulated to a predetermined amount of data and streaming data that changes in real time, and manages the collected network information by separating the collected network information into the unstructured data (text chunk) and the structured data that may use the values of each field as they are, thereby providing the method of reconstructing a physical network that enables service provision by reflecting real-time network conditions even when an unexpected network issue occurs.

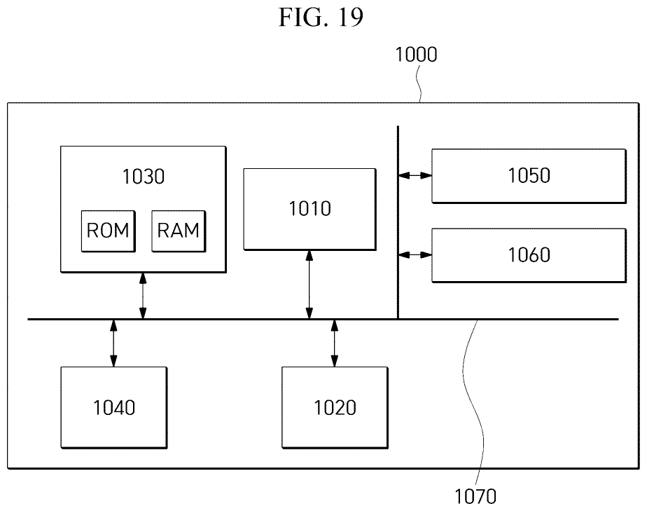

FIG. 19 is a block diagram illustrating a computer system for implementing a method of network control according to an embodiment of the present invention. The network control system 10, the network control command generation device 100, or the apparatus 200 for network control according to an embodiment of the present invention may be implemented in the form of a computer system 1000 of FIG. 19.

Referring to FIG. 19, a computer system 1000 may include at least one of at least one processor 1010, a memory 1030, an input interface device 1050, an output interface device 1060, and a storage device 1040 that communicate via a bus 1070. The computer system 1000 may further include a communication device 1020 coupled to a network. The processor 1010 may be a central processing unit (CPU) or a semiconductor device that executes computer-readable commands stored in the memory 1030 or the storage device 1040. The memory 1030 and the storage device 1040 may include various types of volatile or non-volatile storage media. For example, the memory 1030 may include a read only memory (ROM) and a random access memory (RAM). In an embodiment of the present disclosure, the memory 1030 may be located inside or outside the processor 1010, and the memory 1030 may be connected to the processor 1010 through various known means. The memory 1030 may be various types of volatile or non-volatile storage media, and examples of the memory 1030 may include a ROM or a RAM.

Accordingly, the embodiment of the present invention may be implemented as a computer-implemented method or as a non-transitory computer-readable medium having computer-executable instructions stored thereon. In an embodiment, when executed by the processor 1010, the computer-readable instructions may perform the method according to at least one aspect of the present disclosure.

The communication device 1020 may transmit or receive a wired signal or a wireless signal.

In addition, the method according to an embodiment of the present invention may be implemented in a form of program commands that may be executed through various computer means and may be recorded in a computer-readable recording medium.

The computer-readable recording medium may include program commands, data files, data structures, or the like, alone or in combination. The program commands recorded in the computer-readable recording medium may be specifically designed and constituted for the embodiment of the present invention or be known to those skilled in a field of computer software. The computer-readable recording medium may include a hardware device configured to store and execute the program instructions. Examples of the computer-readable recording medium may include magnetic media such as a hard disk, a floppy disk, and a magnetic tape, optical media such as a compact disc read only memory (CD-ROM) or a digital versatile disc (DVD), magneto-optical media such as a floptical disk, a ROM, a RAM, a flash memory, or the like. Examples of the program instructions may include a high-level language code capable of being executed by a computer using an interpreter or the like as well as a machine language code made by a compiler.

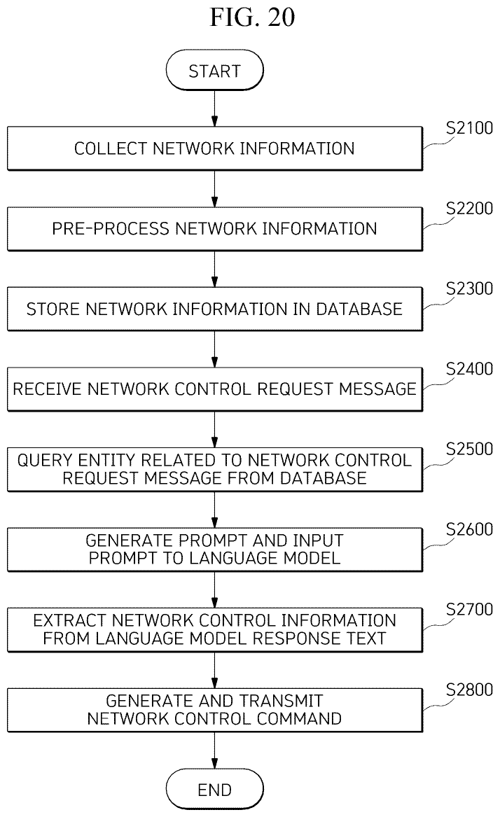

FIG. 20 is a flowchart for describing the method of network control according to an embodiment of the present invention. The method of network control of FIG. 20 is performed by the network control system 10. The method of network control of FIG. 20 is a method of controlling the physical network 20.

Referring to FIG. 20, the method of network control according to an embodiment of the present invention includes operations S2100 to S2800. The method of network control illustrated in FIG. 20 is according to an embodiment, and the operations of the method of network control according to the present invention are not limited to the embodiment illustrated in FIG. 20 and may be added, changed, or deleted as needed. For example, operations S2100 to S2300 may be omitted.

Since the network control system 10 has been described in detail with reference to FIGS. 1 to 19, specific details will be omitted in the description of each operation of the method of network control according to an embodiment of the present invention, which is performed by the network control system 10. A person skilled in the art to which the present invention pertains will be able to understand the specific details of each operation by referring to FIGS. 1 to 19.
Operation S2100 is an operation of collecting network information.

The network control command generation device 100 collects network information in the form of raw data from the physical network 20 and metadata about the network information.
Operation S2200 is an operation of pre-processing the network information.

The network control command generation device 100 pre-processes the network information collected in operation S2100. For example, the network control command generation device 100 may perform one or a combination of organization, transformation, labeling, and feature extraction of the network information.
Operation S2300 is an operation of storing the network information in the database.

The network control command generation device 100 stores the pre-processed network information in the database 115. Based on the metadata, the network control command generation device 100 determines which database of the relational database 115b and the vector database 115a the pre-processed network information will be stored in.
Operation S2400 is an operation of receiving a network control request message.

The network control command generation device 100 receives the network control request message M310 from the operator 40.
Operation S2500 is an operation of querying an entity related to the network control request message in the network information database.

The network control command generation device 100 obtains the entity search result M320 related to the network control request message M310 from the database 115 storing the network information for the physical network 20.

The network control command generation device 100 may generate the entity information query M312 based on the network control request message M310 and input the entity information query M312 to the database 115 to obtain the entity search result M320.

Specifically, the network control command generation device 100 extracts the meaningful information included in the network control request message M310 using the entity extraction model, generates the entity information message M311 including one or more field name-field value pair data based on the meaningful information, defines each field name-field value pair data included in the entity information message M311 as the lookup entity to generate the entity information query M312, and inputs the entity information query M312 to the database 115 to obtain the entity search result M320.
Operation S2600 is an operation of generating a prompt based on the entity search result and inputting the generated prompt into the language model.

The network control command generation device 100 generates the prompt M332 or M340 to be input into the language model 30 based on the entity search result M320 and inputs the prompt M332 or M340 into the language model 30 to obtain the language model response text M350 from the language model 30.

The network control command generation device 100 may generate the prompt M332 by reconstructing the message combining the network control request message M310 and the entity search result M320 into the text prompt format.

The network control command generation device 100 may generate an updated prompt M340 by adding a parameter that controls the response generation of the language model 30 to the prompt M332.
Operation S2700 is an operation of extracting the network control information from the language model response text.

The network control command generation device 100 parses the language model response text M350 to extract the network control information M360. That is, the network control command generation device 100 extracts network control information M360 included in the language model response text M350 by parsing the language model response text M350.
Operation S2800 is an operation of generating a network control command based on the network control information and transmitting the generated network control command to the apparatus for network control.

The network control command generation device 100 generates a network control command M370 based on the network control information M360 and transmits the network control command M370 to the apparatus 200 for network control. The apparatus 200 for network control applies the network control command M370 to control the physical network 20.

Specifically, the network control command generation device 100 may generate the network control command M370 by reconstructing the network control information M360 to fit the network control interface of the physical network 20. The network control interface may be either CLI or RestAPI.

The above-described method of network control has been described with reference to the flowchart illustrated in the drawings. For simplicity, the method has been illustrated and described as a series of blocks, but the invention is not limited to the order of the blocks, and some blocks may occur with other blocks in a different order or at the same time as illustrated and described in the present specification. Moreover, various other branches, flow paths, and orders of blocks that achieve the same or similar result may be implemented. In addition, all the illustrated blocks may be not required for implementation of the methods described in the present specification.

Meanwhile, in the description with reference to FIG. 20, each operation may be further divided into additional operations or combined into fewer operations according to an implementation example of the present invention. Further, some operations may be omitted if necessary, and an order between the operations may be changed. In addition, the contents of FIGS. 1 to 19 may be applied to the contents of FIG. 20 even if other contents are omitted. Also, the contents of FIG. 20 may be applied to the contents of FIGS. 1 to 19.

According to the present invention, by introducing an intelligence function into physical network construction, control, management, etc., based on a language model, it is possible to overcome various issues that may occur due to different hardware-dependent control methods (e.g., network equipment specifications, complex control instructions, etc. based on domain information and characteristics) while constructing the physical network and minimize operator intervention.

In addition, according to the present invention, by providing a language model pluggable device between a language model and a network to control/manage applications and hardware abstraction blocks in a control plane at a high level based on a language model response, it is possible to facilitate the setting/controlling/managing of the physical network.

In addition, according to the present invention, it is possible to obtain the response suitable for the hardware-dependent network control from the language model by extracting the meaningful entity identification information from the natural language when the operator writes the network control request in the natural language, converting the extracted meaningful entity identification information into the single text prompt that may be understood by the language model, and setting the parameter values necessary for text generation control.

In addition, according to the present invention, by querying the database using the extracted entity-specific information when there is the entity extraction model for extracting the meaningful entity identification information from the natural language, and querying all the data determined to be related to the natural language request without separate natural language analysis when there is no entity extraction model, it is possible to query data more delicately and accurately depending on the presence or absence of the entity extraction model.

In addition, according to the present invention, by converting the set (e.g., command line interface (CLI), Representational state transfer application programming interface (RestAPI), etc.) of network control instructions included in the language model response into the format that may be understood by the actual network controller and transmitting the set of network control instructions, it is possible to minimize operator intervention in setting instructions necessary for network control/management.

Moreover, according to the present invention, in terms of collecting data with different control methods depending on hardware, by classifying the collected data into the batch data that is accumulated to a certain extent and has the meaningful data value as the statistical characteristics (e.g., average and standard deviation) and streaming data that requires the real-time reflection, it is possible to effectively pre-process the data.

In addition, according to the present invention, by classifying the collected data into the meaningful batch data as the statistical characteristics and the real-time changing streaming data by being synchronized with the current state of the physical network and by separating the collected network information into unstructured data (text chunks) and structured data that may use values for each field as they are and managing the collected network, it is possible to provide services by reflecting the real-time network conditions even when unexpected network issues occur.

In addition, according to the present invention, by generating the workflow containing the procedures necessary for providing the network services based on the natural language request from the operator and obtaining the response from the language model for each action item, it is possible to implement the desired settings for each network service according to the workflow procedure.

Effects which can be achieved by the present invention are not limited to the above-described effects. That is, other objects that are not described may be obviously understood by those skilled in the art to which the present invention pertains based on the following description.

Although exemplary embodiments of the present invention have been disclosed above, it may be understood by those skilled in the art that the present invention may be variously modified and changed without departing from the scope and spirit of the present invention described in the following claims.

What is claimed is:

1. A method of network control for controlling a physical network, comprising:
receiving, by a network control command generation device, a network control request message from an operator;
obtaining, by the network control command generation device, an entity search result related to the network control request message from a database storing network information on the physical network;
generating, by the network control command generation device, a prompt to be input to a language model based on the entity search result and inputting the prompt to the language model to obtain a language model response text from the language model; and
generating, by the network control command generation device, a network control command based on the language model response text.

2. The method of claim 1, wherein the obtaining of the entity search result includes generating, by the network control command generation device, an entity information query based on the network control request message and inputting the entity information query to the database to obtain the entity search result.

3. The method of claim 1, wherein the obtaining of the entity search result includes extracting, by the network control command generation device, meaningful information included in the network control request message using an entity extraction model, generating an entity information message including one or more field name-field value pair data based on the meaningful information, defining each field name-field value pair data included in the entity information message as a lookup entity to generate an entity information query, and inputting the entity information query into the database to obtain the entity search result.

4. The method of claim 1, wherein the obtaining of the language model response text includes reconstructing, by the network control command generation device, a message combining the network control request message and the entity search result into a text prompt format to generate the prompt.

5. The method of claim 4, wherein the obtaining of the language model response text includes reconstructing, by the network control command generation device, a message combining the network control request message and the entity search result into a text prompt format and adding a parameter that controls a response generation of the language model to generate the prompt.

6. The method of claim 1, wherein the generating of the network control command includes extracting, by the network control command generation device, network control information included in the language model response text by parsing the language model response text and reconstructing the network control information to fit a network control interface of the physical network to generate the network control command.

7. The method of claim 1, wherein the network control interface is one of a command line interface (CLI) and Representational state transfer application programming interface (RestAPI).

8. The method of claim 1, further comprising:
collecting, by the network control command generation device, network information in a form of raw data from the physical network and metadata on the network information;
pre-processing, by the network control command generation device, the network information; and
storing, by the network control command generation device, the pre-processed network information in the database.

9. The method of claim 1, wherein the pre-processing includes, performing, by the network control command generation device, one or a combination of organization, transformation, labeling, and feature extraction of the network information.

10. The method of claim 8, wherein the storing of the pre-processed network information in the database includes determining, by the network control command generation device, based on the metadata, which database of a relational database and a vector database the pre-processed network information is stored in.

11. A network control command generation device for generating a network control command for controlling a physical network, the network control command generation device comprising:
a memory configured to store computer-readable commands; and
at least one processor configured to execute the commands,
wherein the at least one processor is, by executing the commands, configured to receive a network control request message from an operator,
obtain an entity search result related to the network control request message from a database storing network information on the physical network,
generate a prompt to be input to a language model based on the entity search result, and input the prompt to the language model to obtain a language model response text from the language model, and
generate a network control command based on the language model response text.

12. The network control command generation device of claim 11, wherein the at least one processor is configured to generate an entity information query based on the network control request message during a process of obtaining the entity search result and input the entity information query to the database to obtain the entity search result.

13. The network control command generation device of claim 11, wherein the at least one processor is configured to extract meaningful information included in the network control request message using an entity extraction model during a process of obtaining the entity search result, generate an entity information message including one or more field name-field value pair data based on the meaningful information, define each field name-field value pair data included in the entity information message as a lookup entity to generate an entity information query, and input the entity information query into the database to obtain the entity search result.

14. The network control command generation device of claim 11, wherein the at least one processor is configured to reconstruct a message combining the network control request message and the entity search result in a text prompt format during a process of obtaining the language model response text to generate the prompt.

15. The network control command generation device of claim 14, wherein the at least one processor is configured to reconstruct a message combining the network control request message and the entity search result in a text prompt format during a process of obtaining the language model response text and add a parameter controlling a response generation of the language model to generate the prompt.

16. The network control command generation device of claim 11, wherein the at least one processor is configured to extract network control information included in the language model response text by parsing the language model response text during a process of generating the network control command and reconstructing the network control information to fit a network control interface of the physical network to generate the network control command.

17. The network control command generation device of claim 16, wherein the network control interface is one of a command line interface (CLI) and Representational state transfer application programming interface (RestAPI).

18. The network control command generation device of claim 11, wherein the at least one processor is configured to collect network information in a form of raw data from the physical network and metadata on the network information and pre-process the network information, and store the pre-processed network information in the database.

19. The network control command generation device of claim 18, wherein the at least one processor is configured to perform one or a combination of organization, transformation, labeling, and feature extraction of the network information during a process of pre-processing the network information.

20. The network control command generation device of claim 18, wherein the at least one processor is configured to determine, based on the metadata, which database of a relational database and a vector database the pre-processed network information is stored in during a process of storing the pre-processed network information in the database.
